(19) United States
(12) Patent Application Publication
(10) Pub. No.: US 2015/0120595 A1
(43) Pub. Date: Apr. 30, 2015

(54) METHOD AND APPARATUS FOR COMMUNICATION AND COLLABORATION IN AN EDUCATIONAL ENVIRONMENT

(71) Applicant: PTBOARD INC., Reston, VA (US)

(72) Inventors: Zhong ZHOU, Oak Hill, VA (US); Gang LI, Herndon, VA (US); Yiyun HUANG, Oak Hill, VA (US)

(21) Appl. No.: 14/491,267

(22) Filed: Sep. 19, 2014

Related U.S. Application Data
(60) Provisional application No. 61/879,697, filed on Sep. 19, 2013.

(51) Int. Cl. G06Q 10/10; G06Q 50/20

(52) U.S. Cl. CPC G06Q 10/10; G06Q 50/2053
USPC 705/327

(57) ABSTRACT

A system and associated methods are provided for communication and collaboration in an educational environment. Integrated modules are provided for discussions, document sharing, photo sharing, events and invitations, and sign-ups. The system comprises a database adapted to allow dynamic formation of groups associated with activities or courses and notification of members of those groups regarding posting of information.

### CROSS REFERENCE TO RELATED APPLICATION

This application claims the benefit of priority from U.S. Provisional Patent Application 61/879,697, filed Sep. 19, 2013.

### BACKGROUND OF THE INVENTION

The present invention relates generally to systems and methods for facilitating communications and information sharing for an educational environment such as an elementary school.

Educational environments present unique communications issues. There is a constant need for communication not only between teachers and parents, but also amongst parents. Year-by-year, or semester-by-semester, enrollment changes lead to significant changes in which parties need to share information with which other parties. Furthermore, various activities, such as parent-teach conferences, field trips, fairs, clubs, fund-raising events, sports teams, and parties, each present their own unique communications needs.

Conventional means for addressing these problems have included school or class newsletters, photo sharing web sites, email communication, paper forms, school directories, parent sign-up sheets, school announcement emails, and volunteer sign-up sheets. These conventional communications solutions fail to efficiently address the problems of educational communication. Emails are hard to organize and search. Paper communication is hard to manage, costly, and not green. Web sites generally manage only discrete portions of the needed information and are hard to manage and organize Furthermore, replicating class lists, keeping them synchronized, and creating logins across multiple services is a time-consuming nuisance.

What is needed is an integrated and interactive platform that supports the needs of both parents and teachers, allowing effective and efficient management of students' activities and enables communication, collaboration, sharing and organization among parents and between teachers and parents.

### BRIEF SUMMARY OF THE INVENTION

A system and associated methods are provided for communication and collaboration in an educational environment. Integrated modules are provided for discussions, document sharing, photo sharing, events and invitations, and sign-ups. The system comprises a database adapted to allow dynamic formation of groups associated with activities or courses and notification of members of those groups regarding posting of information

### BRIEF DESCRIPTION OF THE DRAWINGS

The foregoing summary, as well as the following detailed description of preferred embodiments of the invention, will be better understood when read in conjunction with the appended drawings. For the purpose of illustrating the invention, there are shown in the drawings embodiments that are presently preferred. It should be understood, however, that the invention is not limited to the precise arrangements and instrumentalities shown.

FIG. 1 is an exemplary system diagram of the communication and collaboration system;

FIG. 2 is an exemplary entity relationship diagram for a database design of a communication and collaboration system of FIG. 1;

FIG. 3 is an exemplary login screen for a communication and collaboration system of FIG. 1;

FIG. 4 is a calendar interface of a communication and collaboration system of FIG. 1;

FIGS. 5-7 are examples of user interface screens related to information sharing using a communication and collaboration system of FIG. 1; and

FIGS. 8-14 are examples of user interface screens related to the process of registering for classes using a communication and collaboration system of FIG. 1.

### DETAILED DESCRIPTION OF THE INVENTION

Certain terminology is used in the following description for convenience only and is not limiting. The words “lower,” “bottom,” “top” and “upper” designate directions in the drawings to which reference is made. The terminology includes the above-listed words, derivatives thereof, and words of similar import. Additionally, the words “a” and “an”, as used in the claims and in the corresponding portions of the specification, mean “at least one.”

Referring to the drawings in detail, wherein like reference numerals indicate like elements throughout, a preferred communication and collaboration system 100 for transmitting messages between and amongst teachers, parents, and students is described.

The system provides a platform for parents and teachers to communicate, collaborate, share, organize and plan for their children's school activities. Among other advantages, the system allows parents to more easily manage their involvement at school and the activities of their children.

The system provides an integrated and interactive platform that allows parents effectively and efficiently manage their children's activities and their school involvement and streamlines communication, collaboration, sharing and organization among parents and between teachers and parents. The system provides unique tools for parents and/or teachers including signup, invitation, photo sharing, discussion, and document sharing within classrooms or the school. Different levels of group activities are aggregated, including school activities, classroom activities and private group activities. Teachers can publish school/classroom notes to multiple classrooms. School calendar, group/classroom calendar, private group calendar and personal calendar in a centralized calendar view, or overlay.

Examples of school activities include book fairs, ice cream socials, clubs, plays, and sports practices, parent-teacher conferences, projects, class photos, and volunteer opportunities. Private activities may include birthday parties, carpools, play dates, and study groups. Signups, invitations, discussions, document sharing, photo sharing, and calendar functions are integrated in the system around activities.

The system provides the advantage of allowing a parent to manage school activities of all of his or her children in a single place, despite the children being in different schools and in different after-school activities. The system may also allow management of personal events along-side school-related events.

Over time, parents may view the history of their children's involvement in their schools. Records of activities, including photos of activities and discussions, may be preserved long after a child has ended his or her affiliation with the school.

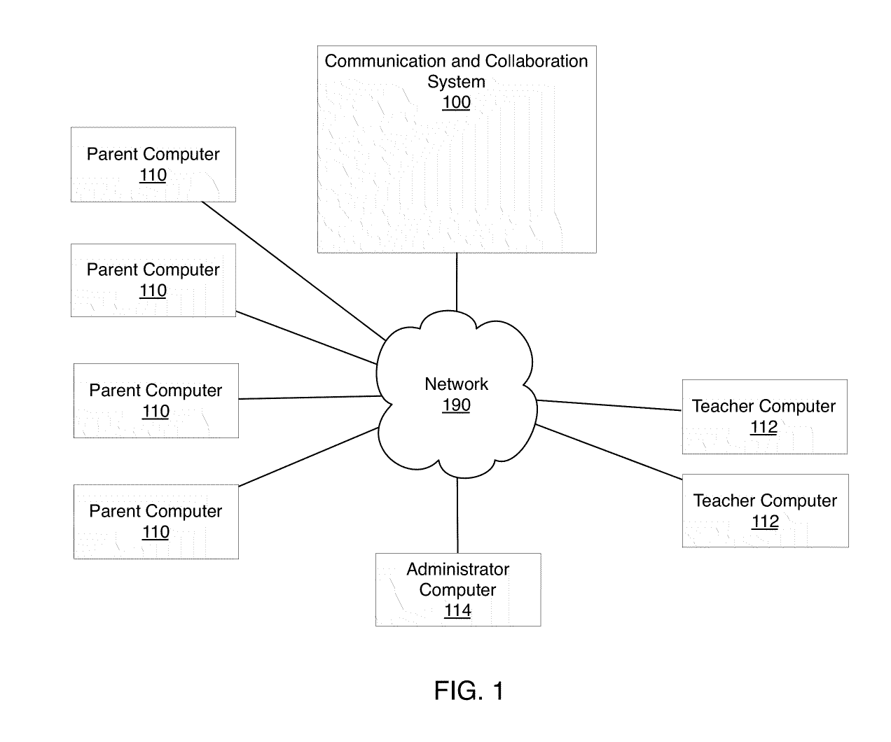

Referring to FIG. 1, the communication and collaboration system 100 communicates over a network 190 with parent computers 110, teacher computers 112, and administrator computers 114. Parent computers 110, teacher computers 112, and administrator computers 114 may be any sort of computing device, such as a desktop computer, laptop, tablet, mobile phone, or kiosk.

The system 100 may be implemented using one or more compute platforms. Certain functions, such as database and web serving, may be allocated to one or more separate physical or virtual machines and/or load-balanced. Program code for the system may be implemented in one or more languages. User interface elements may be stored or generated dynamically and transmitted at least in part preferably in a markup language such as HTML. Network 190 may comprise various wired or wireless LANs, WANs, cellular networks, and the Internet. Users may preferably connect to the system via the Internet from a web browser. One or more hard drives or arrays of hard drives may be used to store program code and data. One or more processors may execute program code associated with the system.

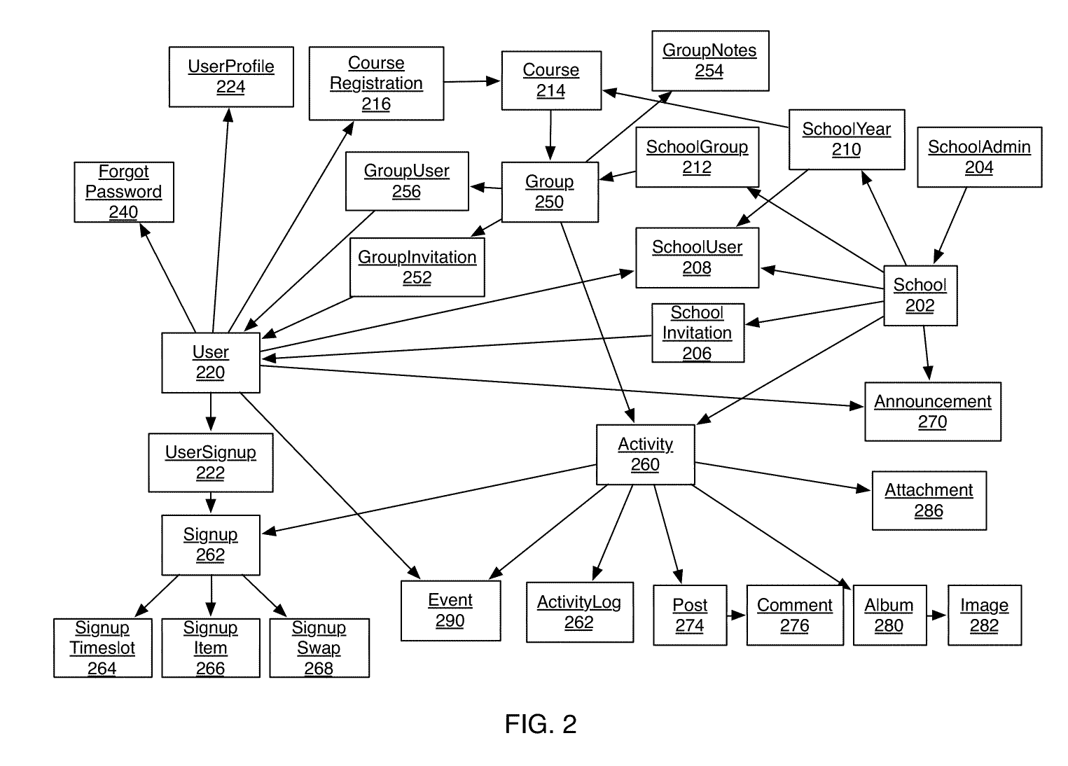

FIG. 2 is an example of a portion of an entity relationship diagram associated with a database of communication and collaboration system 100. Aspects of the entities stored within the database and the associated system functionality are described below.

In a preferred embodiment, a split schema design is utilized for storage of system data. User, group, and school information may be stored in a relational database, while activities and related entities may be stored in a NoSQL database (e.g., Hadoop Database or HBase). Additionally, large data items, such as attachment documents or photos, may be stored in a separate third-party storage system, such as Amazon S3.

### Entities

### School

The communication and collaboration system may manage communications for multiple schools over multiple school years. In a preferred embodiment, each school is represented by a row in a “school” table 202. Each school record in the school table 202 preferably comprises information such as an ID, name, description, link to a logo, address data, web site information, status, a time the school was created, identifying information such as an NCES ID, and the user ID of the creator of the school record. A school entity may be considered a special form of the group entity described below, or a school may have a default group representing the entirety of the school.

A school may have one or more school administrators. School administrators may be recorded in a “schooladmin” table 204. Each row of the table comprises a school ID and a user ID.

Users are invited to be associated with a school. Invitations are managed via a “schoolinvitation” table 206. Each row of the table may comprise the email address of the invited party, the school ID, the school year ID for which the invitation is relevant, and ID of the user initiating the invitation, an indicator of the role to which the user is invited to participate, an access token, a creation time for the invitation, and a default group. Rows of the table may be preferably removed as invitations are accepted.

The access token may be included in the invitation and serve as a shorthand method of indicating the invitation in question when the user responds. For instance, the access token may be provided as a part of a URL provided to the user in an email with the invitation.

Users associated with the school may be managed via a “schooluser” table 208. Each row of the table may comprise a school ID, a user ID, the ID of a school year, a status indicator, a role indicator for the user relative to that school, and an indicator of the user's last access time.

A “course” table 214 comprises records for each course. A “course registration” table 216 comprises information regarding the relationship between users and courses.

Much of the data in the system is organized around the concept of a school year. This reflects the real-world fact that many affiliations in a school, such as class membership and group membership, are assigned on a year-by-year basis. A “schoolyear” table 210 may be used to record information regarding each school year. Each row may comprise a school Id, a school Year ID, a code, and start and end dates for the school year. The school year ID may preferably be the four-digit calendar year of the year in which the school year ends. The school year ID may be used in other data entities to represent the association with the school year.

When a class is added to a school, it is associated with a school year. A default class activity may be automatically created for the school year. An associated entry in a SchoolGroup table 212 may have a schoolYear field to provide this correlation.

Once a school year is completed, data related to the school year, such as information related to activities and groups, may be archived. Read-only access may preferably be provided to the data from past school years.

When a school year is archived, each associated course or class is marked as closed. In such condition, no person can join or leave the class. Upon archive, all activities associated with the school year will be put under read-only mode. Associated users may go back and review or search existing content, discussions, photos, etc., but cannot add or update data.

Data from a school profile may be carried over to subsequent school years. The administrator may only need to edit start and end dates to establish the new school year. All existing users may be automatically moved to next school year, and would then need to join new classes for the new year. Alternatively, all prior users may be invited to join the new school year or users for the new school year may be loaded from a data source such as a school directory spreadsheet.

### School/Class Invitations

Invitations may be issued via the upload of a spreadsheet with parent name, student name, parent address, etc. Using this method, the user may be invited to the school and/or class, and also added to a school directory tab. The user may also be invited to a school or class via email. The system may preferably provide a function to allow the administrator to invite all users from a previous school year.

### Users

A “user” table 220 may be used to store information regarding users of the system. Each row of the table may comprise an ID for the user, an email address, first and last names, a middle initial, a status, a password, an indicator of the user's role, a creation time for the user account, and an alternative email address. In a preferred embodiment, the role in the user table relates to the user's role relative to the system, such as administrator versus user, rather than the user's role in relation to a school.

### User Signup

A “usersignup” table 222 may be used to manage user signups. Each row may comprise an ID of the user engaging in the signup, an ID of the signup item, a quantity, where appropriate, an ID of the user assigning tasks or items, an ID for the event for which signup is being performed, a creation time for the user signup entry, and an email address.

The use of an email address in user signup allows for situations in which a person being invited for signup may not yet have a user account on the system. Thus, the system may allow lists for signup or invitation to include registered as well as non-registered users. For known users, the system may pre-populate or not ask for email addresses.

In a preferred embodiment, if a user does not yet have an account with the system and received a signup notification, the system may force the user to register before completing the sign up process. In the case of invitations, however, the user may be allowed to accept the invitation without registering.

### User Profile (Key is User Id)

The system may store additional information related to the user. For instance, a “userprofile” table 224 may store additional information about the user not contained in the “user” table, such as a mapping to avatar data.

### User Roles

In a preferred embodiment, a user is assigned one of three roles: administrator, parent, or teacher. A user with the Parent role can join or leave a school if invited or if he or she pays the membership fee. A Parent may also join or leave classrooms within the school, and can manage private groups as an owner. A user with the Teacher role may create and publish school/classroom notes and perform all functions of the Parent role. A user with the Administrator role may be a school staff member or a designated PTA/PTO member. Administrators are allowed to set up classrooms, invite parents to join the site, manage users and roles, create and manage school level announcements, forms, activities, and calendars, and perform all functions allowed in the Teacher and Parent roles.

In a preferred embodiment, students themselves are not users. Each registered parent user may have zero or more students, and the parent will be a “member” of all his/her students' classes. Each class registration sheet will show which students are in the class.

A “forgotpassword” table 240 may be used to manage data related to password recovery. Each row may comprise a token, a user ID, and a request time.

### Groups

Users may be organized into groups. In a preferred embodiment, a class or course is represented as a group.

A “group” table 250 may be used to manage data related to groups. Each row may comprise a group ID, a group name, a group description, a group type, a status, a creation time, a user ID of the creator of the group, an ID of the school to which the group is associated, and a school year to which the group is associated.

Users may be invited to join groups through an invitation process. A “groupinvitation” table 252 may be used to store data related to invitations to groups. Each row may comprise an email address of the invited party, an ID for the group, a user ID of the person initiating the invitation, a role, an access token, a creation time, a name, and a user ID.

Notes related to a group may be stored in a “groupnote” table 254. Each row may comprise the ID of the user creating the note, the ID of the group to which the note is associated, and an announcement ID.

The association of users with groups may be recorded in a “groupuser” table 256. Each row of the table may comprise a user ID, the ID of the group, a status of the group membership, a role for the user relative to the group, and a type.

### Activities

Activities are a core feature of the system and a central focus of the design. In a preferred embodiment, activities of each type may be associated with discussions, attachments, photo sharing, signups, and invitations. Since information is organized in an activity-centric manner, the system provides a significant usability advantage over the user of separate single-task sites for photos, calendars, and signups, where the information is necessarily organized by the type of information. By accessing a page for an activity, the user may be provided with all of the available information for that activity with a single site login.

A group or school may have one or more activities. An “activity” table 260 may be used to record information about these activities. Each row of the table may comprise a title, a description, an event type, and a user ID of the user creating the activity.

In a preferred embodiment, three different activity types are provided: 1) School activity, 2) Class or course activity, and 3) Private activity. For class activities, once a class is created, a default class activity will be created with the same name as the class name.

### ActivityLog

The system may maintain various logs. For instance, an “activitylog” table 262 may record the ID of log items along with a category and the message to be logged.

### Signup (Parent is Activity):

The system may provide the ability to create signup sheets for various activities. A “signup” table 262 may comprise rows recording a name, a description, a user ID of the creator if the signup entry, an item sequence, a type, a status, an indicator of whether the signup is swappable, an indication of whether the signup is multi-signable, an ID of the parent activity, and a theme.

Signups may comprise one or more signup sheets for timeslots. Timeslots may comprise one or more signup sheets for providing items or resources for an event.

### Signup Timeslot (Parent is Signup)

Some signups, such as parent-teacher conferences or bake sales, may require signup for specific timeslots. A “signuptimeslot” table 264 may record information about available time slots, including start and end times, location, and a description related to the timeslot. Each signup may have one or more signup timeslots, and each timeslot may have zero or more signup items. A first timeslot may be automatically created by the system.

### Signup Item (Parent is Signup Timeslot)

A “signupitem” table 266 may record the ID, name, description, desired quantity, and type of items needed for an event. For scenarios like a party, the signup may have one timeslot with all signup items belong to that timeslot. For a parent-teacher conference, there may be multiple timeslots, and each timeslots, with each timeslot having only have one signup item. For some volunteer situations, there may be multiple timeslots, with each timeslot need multiple items (e.g., parents).

### Swap

The system may accommodate user requests to exchange or swap commitments to timeslots or items. In a preferred embodiment, a “signupswap” table 268 is used to record information regarding requested swaps. Each row comprises an ID of the swap, an ID of the user currently signed up for the spot, an ID of the user requesting the spot, a time of modification, and a status.

### Notes and Announcements

In a preferred embodiment, announcements can be easily published to different groups, such as a school or a class. An “announcement” table 270 may be used to store information regarding the announcements. Each record may comprise a title, the body of the announcement, the ID of the user who created the announcement, and the ID of an attachment.

Teachers can create school/classroom notes for parents. Notes can be published to multiple classrooms. A user in the school administrator can create school-wide announcements. Fields for entry of notes and announcements preferably allow entry of rich text.

### School Forum

In addition to the classroom discussions, a school-level forum may also be provided. All topics can be discussed at school level and all parents in the school can participate. Attachments can be embedded in the discussions.

### School Directory

A school directory is provided with a live listing of all users associated with the school. Individual users with associations with multiple classrooms may appear multiple times in the directory associated with each of those classrooms. A school administrator may bulk create school parent directory. The directory may be exported in a form such as Microsoft Excel.

### Post/Comments

Activities may have associated posts. A “post” table 274 may record ID, subject, and body of the post, the ID of the user making the post, and the ID of the parent activity. Users may add comments to “posts.”

A “comment” table 276 may record the ID and body text of a comment, as well as the user ID of the user making the comment.

### Album/Image

Activities may have associated albums of photos. An “album” table 280 may record information related to these albums. Each row may comprise an ID of the album, the ID of the activity to which the album is associated, a title for the album, the user ID of the user who created the album, and the ID of the parent activity.

An “image” table 282 may then store information regarding photos associated with each album. Each row of the table may comprise an image ID, the ID of the album to which the image belongs, a caption, an indicator of image type, and the ID of the user who added the image to the album.

### Attachment (Parent is Activity)

The system may provide the ability to add attachments related to activities. An “attachment” table 286 may store information related to these attachments. Each row may comprise an ID of the attachment, an ID of the activity to which the attachment is associated, a description, a name, a key, and a user ID of the creator of the attachment. The key may be an identifier allowing access to the attachment data in a local or remote storage. In a preferred embodiment, attachment data is stored in Amazon S3 storage and the key is an Amazon S3 key for the stored file.

### Event (Parent is Activity or User)

An Event table 290 stored information related to events. Each event row may comprise start and end times, a title, a description, a location, an indication as to whether the event is an all day event, an indication of the period of recurrence of the event, a recurrence ending date, information related to a reminder, and a user ID of the creator of the event. The event row may also comprise an ID of a parent activity or user.

It is to be understood that while the entities and their relations have been described with particular names, the names themselves may vary within the scope of the invention. It is also to be understood that variants of the system may utilize more or fewer tables than those described. For instance, certain instances of the system may omit functions such as photo sharing, with the relevant tables being either not present or not utilized.

### Features

The system provides a wide variety of features and functions associated with the data entities described above. Access to these features and functions is preferably restricted to authenticated users.

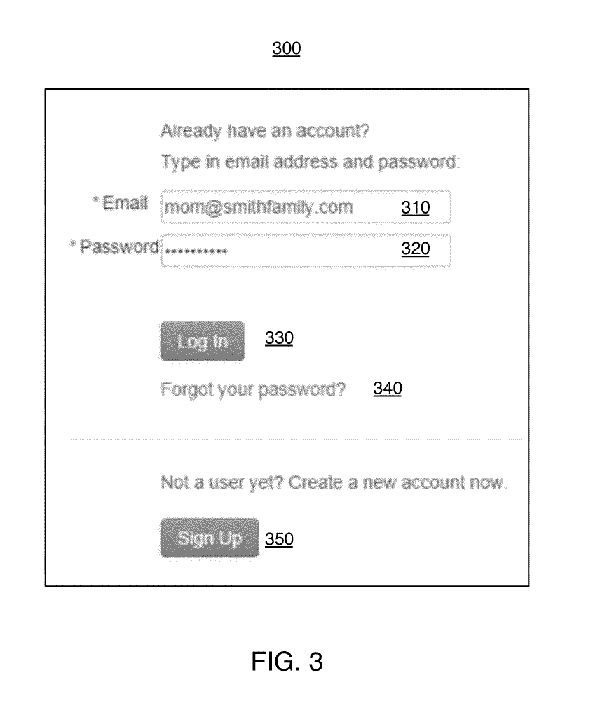

FIG. 3 is an exemplary login screen for the communication and collaboration system 100. The login screen may be presented to a user, for instance, at a computer 110, 112, 114, or at a mobile device service the same role. Portions of the user interface 300 are provided for entry of an email address or username 310, entry of a password 320, initiating login 330, requesting or resetting a password, or signing up for an account 350. It is to be understood that while a login screen has been described, other access control mechanisms known in the art may also be utilized within the scope of the system.

### Calendar

In a preferred embodiment, three types of calendars are provided: School calendar, Group calendar, and Personal calendar. The user may be provided with an overlay view of these calendars. Activities, invitations, and sign-ups with time information will be automatically added to a school, group, or personal calendar upon creation. Email reminders may be sent to parents prior to events, if configured by the creator of the calendar event.

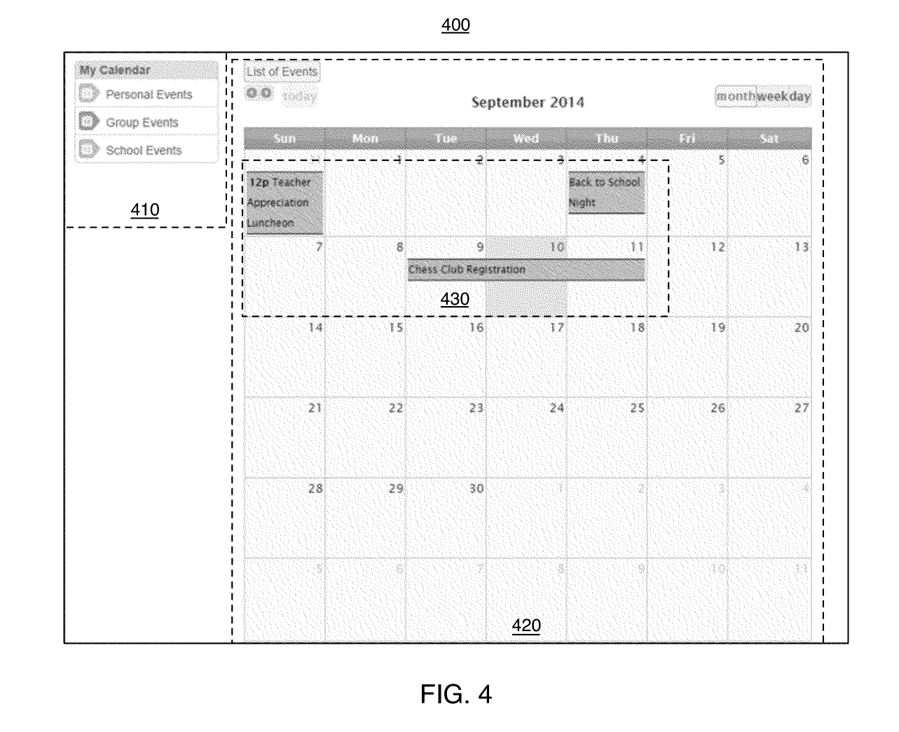

FIG. 4 is a calendar interface of a communication and collaboration system of FIG. 1. User interface elements preferably include elements for selecting the type of calendar 410, for viewing the calendar 420, and for viewing and selecting events on the calendar 430.

### EXAMPLE

The purposes and relationships between the various tables of the described database schema may be clarified through discussion of an example usage scenario.

After an administrator logs in, the system may query school and school year tables by school ID and current school year and return the relevant school information. The administrator provides information for creation of a registration for a session, such as “summer camp,” for the relevant school and school year. The system then inserts a record into the Course Registration table.

The administrator then provides input regarding a course, such as “chess club,” to be added to the “summer camp” session. Upon submission of the class data, the system inserts the data into the Course table with reference to the registration “summer camp”.

Later, a parent user may log in. The parent is presented with available registrations for the school ID with which they are associated, such as the newly created “summer camp.” That is, the “summer camp” registration is displayed by the system to the parent because this parent is an active member of the school for the current school year. This relationship is determined using data from the SchoolUser table.

The parent adds his child to his profile by entering information about the student, causing the system to create a record with the information in the Student table with reference to the parent user ID. If the parent enrolls a student in the “chess club” class, the system records this enrollment by associating and inserting his child ID and the course ID into the CourseRegistration table. After a parent pays the tuition, the system activates his child or student as an active member of this class.

The system also creates a dynamic group for this class roster for “chess club” with reference to the Course ID. This group dynamically displays this group to parents of students in the associated course. Parents may select this group, post a discussion topic, post comments to other parents' topics. The system creates post records in a Post table with reference to the group ID.

Parents may also create photo albums and upload photos for sharing. The system creates photo records in an Album table with reference to the Group ID. Parents may also upload documents for sharing, which are referenced in an Attachment table, again with reference to the corresponding Group ID.

Teachers associated with a group may publish class notes and forms to a group, which may be referenced in records of an Announcement table with reference to the group ID. A teacher may create a sign-up, such as “chess club volunteer sign-up.” The system will create a signup record with reference to the “chess club” group ID in a Signup table. Parents associated with the Group may then be presented with a user interface allowing them to sign up. Upon entry of required information by the parent, the system insert a sign-up record into the UserSignup table, associating the signup ID and the parent ID.

The teacher creates an invite, such as “celebration party,” with reference to the “chess club” group ID, the record is created in Invitation table. Parents accept the “celebration party” using the user interface and the system inserts a record into the UserSignup table associating the corresponding invite ID and parent ID.

### User Interface

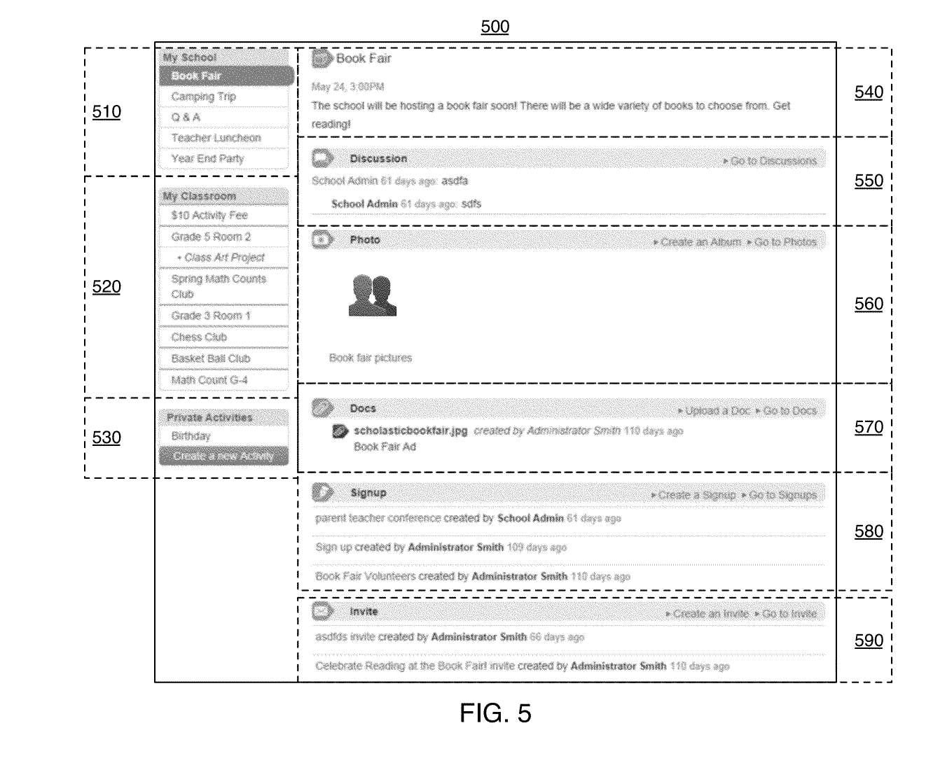

FIG. 5 is an exemplary user interface 500 for presentation of a school activity. The user interface provides access to appropriate school 510, class 520, and private 530 activities for the user. In a preferred embodiment, a dashboard view for a particular activity presents a name and description of the activity 540, discussion 550, photos 560, documents 570, signups 580, and invitations 590 associated with the activity on a single screen for easy access. Individual tabs for discussion, photo, attachment, forum, signup, and invitation, may present only that portion of information related to the activity.

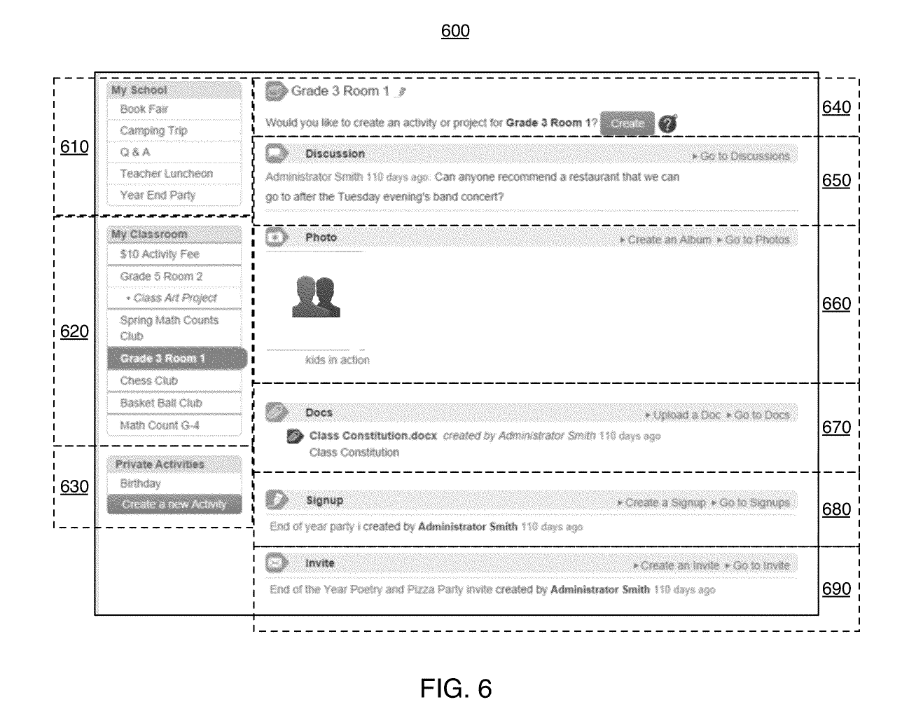

FIG. 6 is an exemplary user interface 600 for interaction with a class activity. The user interface provides access to appropriate school 610, class 620, and private 630 activities for the user. In a preferred embodiment, a dashboard view for a particular activity presents a name and description of the activity 640, discussion 650, photos 660, documents 670, signups 680, and invitations 690 associated with the activity on a single screen for easy access. Individual tabs for discussion, photo, attachment, forum, signup, and invitation, may present only that portion of information related to the activity.

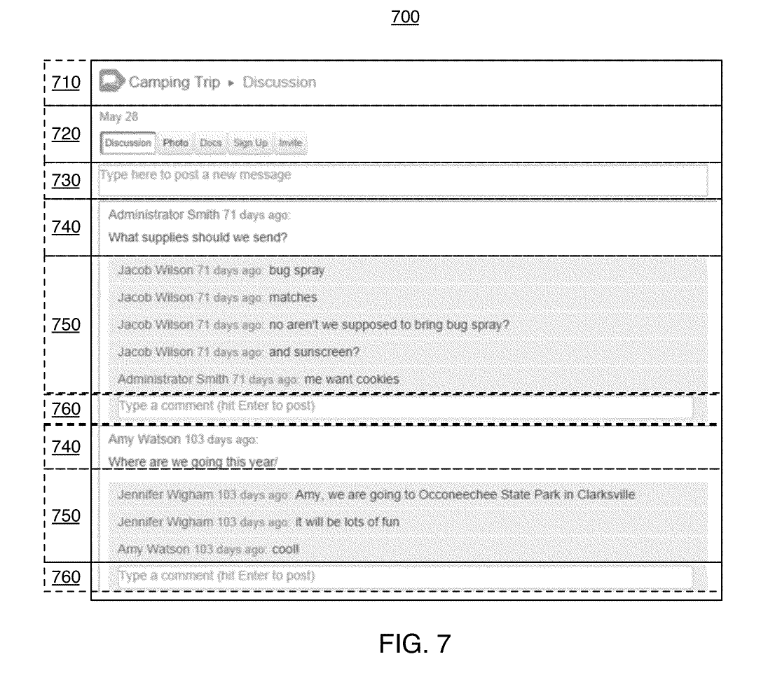

FIG. 7 is an exemplary user interface 700 for the discussion tab of an Activity. User interface 700 preferably comprises interface elements for presenting the name or other identifying information related to the Activity 710, selecting tabs for items relevant to the Activity 720, and entering messages 730, as well as for presenting the messages themselves 740, presenting comments related to the messages 750, and for entering comments related to the messages 760.

### Registration Process

A user in an administrator role may create “registrations” associated with an education period such as a course, semester, or school year. A registration may comprise, for instance, a single class, all of the classes for a particular semester, or a school year. Once a registration has been created, users may register for classes for the associated semester or school year.

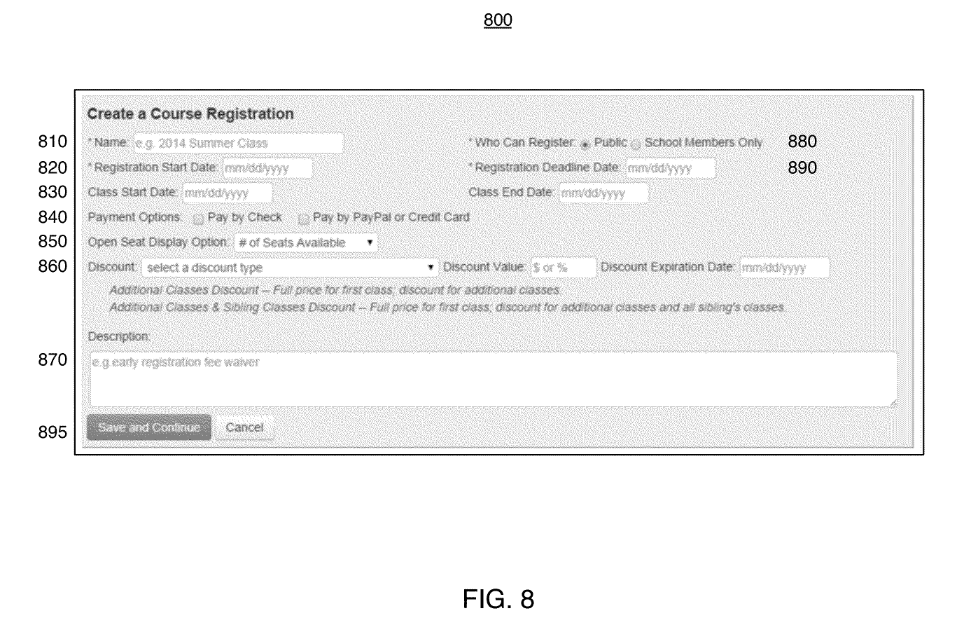

FIG. 8 is an illustration of an exemplary user interface 800 for creating a new course registration. The administrator creating the course registration may be provided with a user interface 800 with entry fields, for instance, for the name of the course 810, registration start date 820, class start date 830, payment options 840, open seat display options 850, discount options 860, course description 870, restrictions on who may register 880, and registration deadline 890. A submission button 895 may be provided for submission of the course registration information.

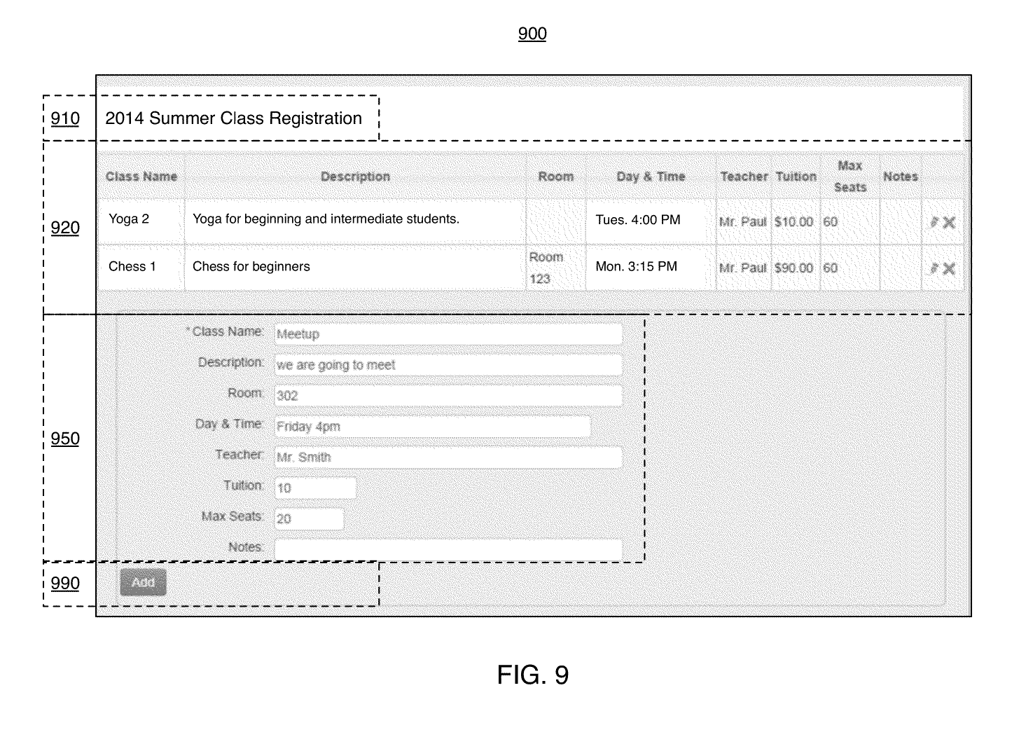

As shown in FIG. 9, the administrator may then use user interface 900 to add individual classes or courses 920 associated with the registration 910. In a preferred embodiment, for each class, fields 950 are provided for the entry of a class name, class description, room, date and time, number of seats available for registration, teacher, tuition amount, and notes. The fields to be presented may be configured based upon the registrations policies and nature of the school. A function may preferably be provided to copy all class names from a prior school year to the new school year, which may then be edited by the administrator. A submission button 990 is preferably provided to allow the user to indicate when all data has been entered and the new class should be added.

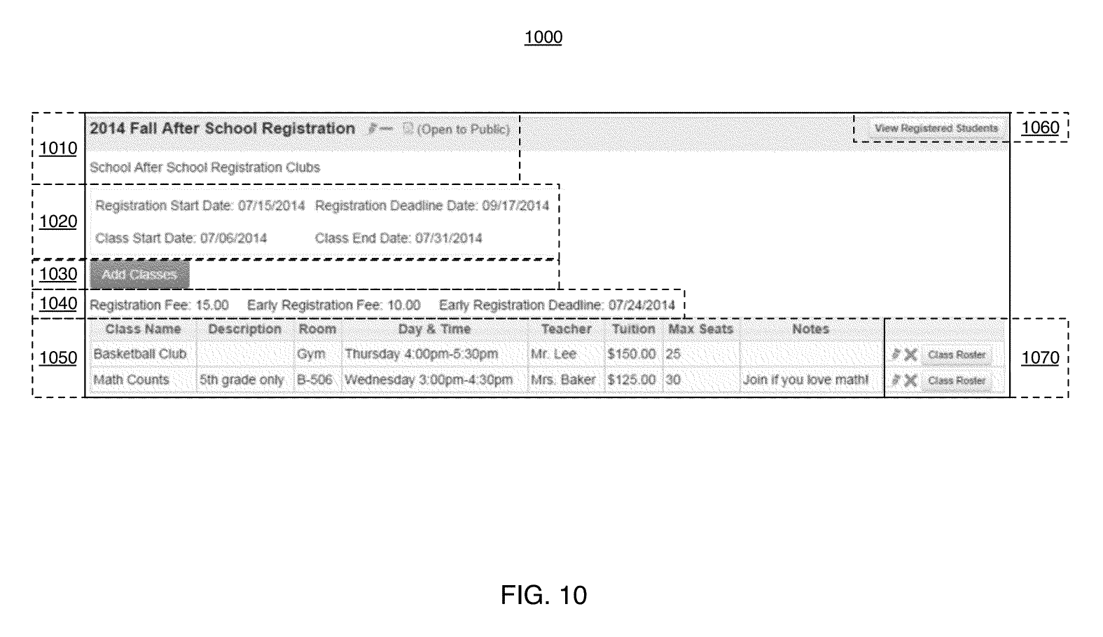

FIG. 10 shows an example of a listing of courses after entry of data into the form of FIG. 9. The user interface 1000 preferably displays a name and description 1010 for the selected registration, information 1020 regarding relevant dates for the registration, a user interface element for adding an additional class to the registration 1030, fee and deadline information 1040, and a listing 1050 of information regarding the existing classes for the registration. The user interface element for adding classes 1030 may bring the user to a user interface such as that of FIG. 9. A user interface element 1070 may be present for each listed class to allow viewing of the roster. Another user interface element 1060 may be present for providing a combined list for all classes associated for the registration. In a preferred embodiment, a student registered for multiple classes may appear multiple times in the list of registered student with separate statuses, such as payment status, listed for each class.

After an administrator has created the registration, parents or students may then, after the registration start time, sign up. In the present example, the user of the system is a parent or guardian registering a student. However, it is to be understood that the system may be adapted to allow students themselves to act as users in appropriate environments.

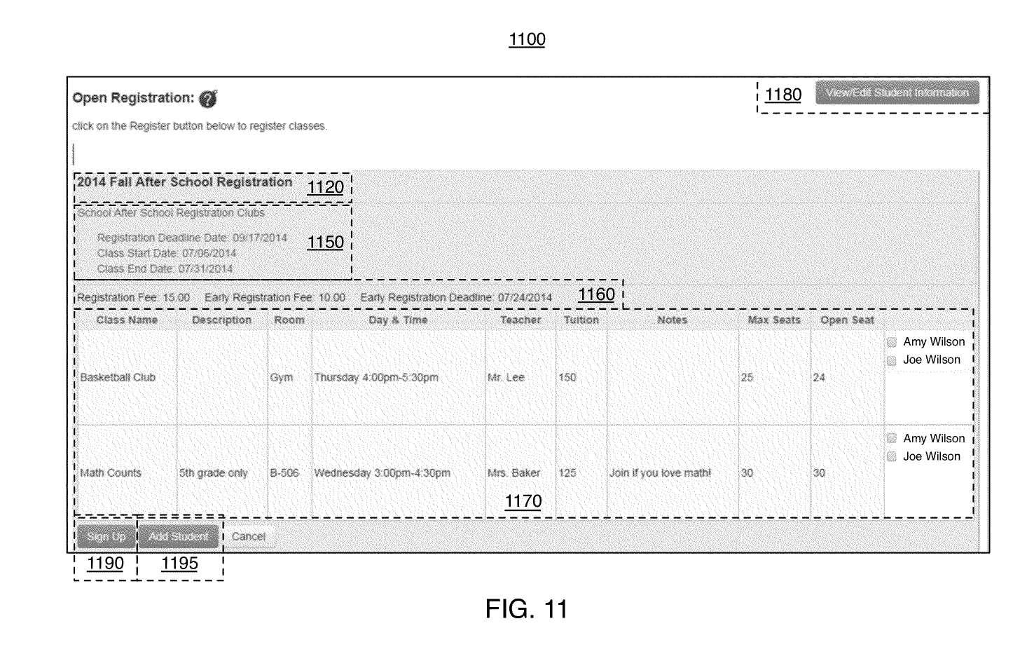

FIG. 11 is an illustration of a registration form 1100 for student registration. In this example, the user is a parent with two students enrolled at the school. The user interface form 1100 preferably displays information regarding the name of the registration 1120, information regarding the registration 1150 such as a description and relevant dates and deadlines, and information regarding registration fees 1160.

Courses associated with the selected registration are displayed to the user in a list 1170. Course listings are preferably accompanied by buttons allowing the user to sign up, or in the case of a class that has already reached its enrollment limit, add the user to a waiting list. In this example, separate checkboxes are provided for each of the two students associated with the user, allowing simultaneous registration of both students for classes in the 2014 Fall After School Registration.

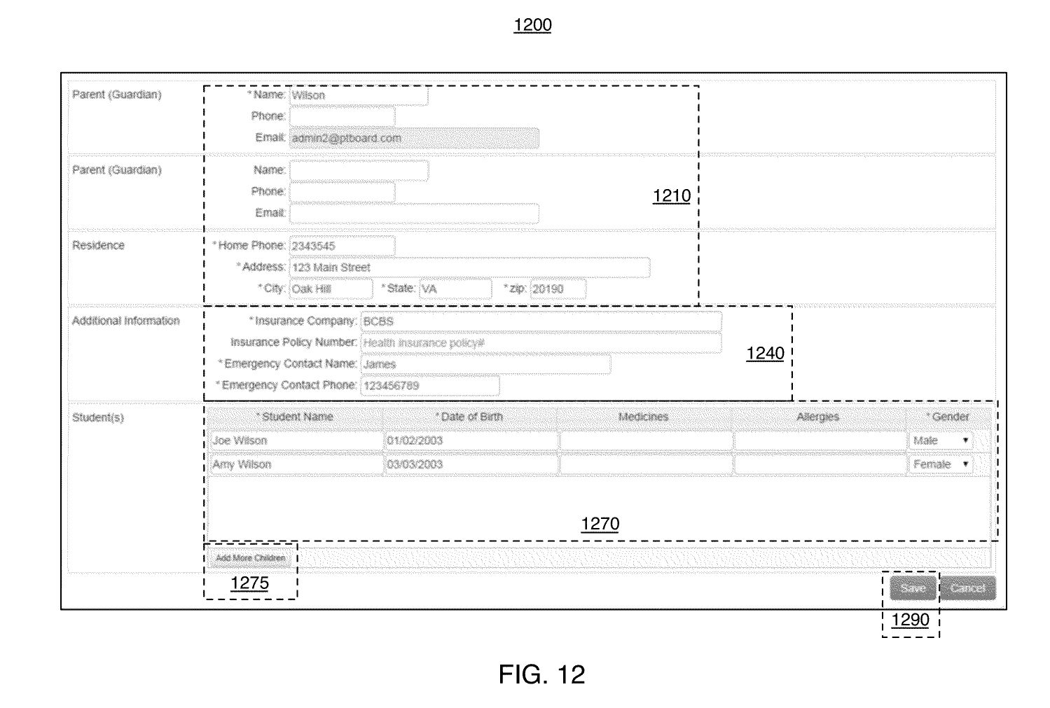

FIG. 12 is an exemplary user interface 1200 for entry of information regarding the user and associated students. The user interface preferably provides input fields 1210 for information related to the parent/guardian user, input fields for health and emergency contact information 1240, and input fields for information 1270 regarding the students associated with the user. The interface further provides a user interface element for adding additional students 1275.

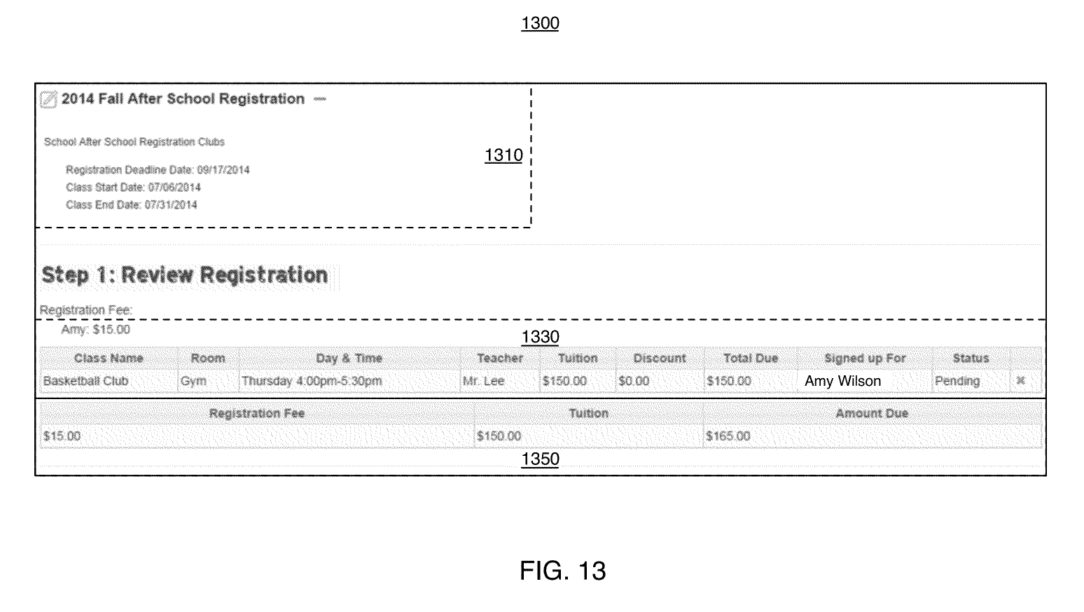

FIG. 13 is an illustration of a confirmation screen 1300 presented after the user has selected the signup button associated with a course. The confirmation screen 1300 preferably comprises information regarding the registration session 1310, information regarding the class or classes for which the student is being registered 1330, and fee information 1350. Information 1330 preferably comprises details of the course that was selected and a user interface element to allow the course to be removed.

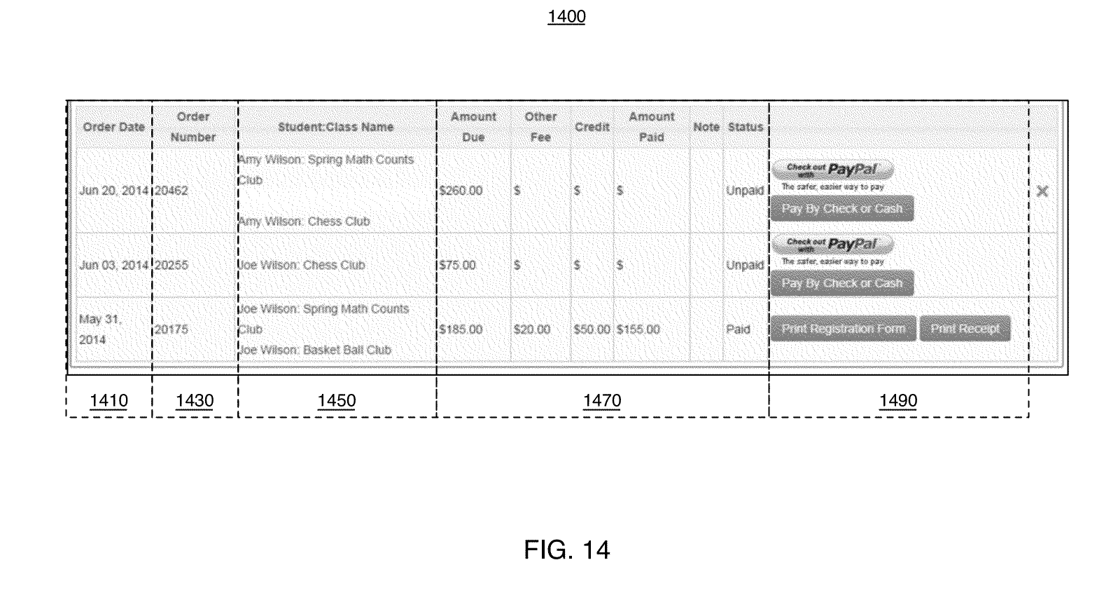

FIG. 14 is an illustration of an order history display 1400. In a preferred embodiment, the order history display 1400 may be presented with the user interface 1300 of FIG. 13. Display 1400 preferably comprises information regarding order data 1410, order number 1430, the class registration 1450, including an indication of student, payment status and amount due 1470, and user interface elements for initiating payments using one or more payment mechanisms 1490.

After registration is complete, the system may product or present a class registration summary and signature form. The form preferably comprises information about the student's course selections and biographical information. The form may also optionally comprise a signature block for use in environments where a signed paper confirmation is required from the student.

After sign up, the administrator will have a view of all students for that class, with a dropdown to indicate paid or unpaid status. Once the administrator selected “paid,” the administrator can enter a check number to that row. The user confirmation page for that user will change the course registration status from pending to complete.

As users register, or after the completion of the registration period, the administrator may generate a comma-separated-value (CSV) or other report listing the registered users and their sign-up information, which can be passed to other entities such as an accounting department.

### Conclusion

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the present disclosure.

We claim:

1. A method of facilitating communications using a communications system comprising a database storing database table data, a processor for executing program code, and a network connection for sending and receiving data, comprising:
receiving, over the network connection, information from an administrator user regarding a registration session;
adding a first registration session record to a registration session table stored in the database, the first registration session record comprising a first registration session ID;
receiving, over the network connection, information from an administrator user regarding a first course associated with the first registration session;
adding a first course record to a course record table, wherein the first course record comprises a first course ID and the first registration session ID;
adding a first group record to a group table, wherein the first group record comprises a group ID and the first course ID;
causing display of a list of courses associated with the first registration session, including the first course, to each of a plurality of non-administrator users;
receiving, over the network connection, information from each non-administrator user of the plurality of non-administrator users regarding a student registration for the first course;
for each student registration for the first course, adding a student course registration record to a student course registration table, wherein the student course registration record comprises a student ID associated with the student registration and the first course ID; and
for each student registration for the first course, adding a group user record to a group user table, wherein the group user record comprises the first group ID and a student ID for the student.

2. The method of claim 1, further comprising:
validating first login information associated with a first user ID, wherein the login information is received from a first user over the network;
performing a database query to determine a list of group records in the group table associated with a student ID associated with the first user ID; and
causing the display of information regarding at least one group associated with at least one of the group records from the list of group records to the user associated with the first user ID.

3. The method of claim 2, further comprising:
receiving information from the first user related to a post related to the at least one group associated with at least one of the group records from the list of group records to the user;
creating a first post record in a post table, wherein the post record comprises the first user ID, a first post ID, and either the group ID of the at least one group or an activity ID of an activity associated with the at least one group.

4. The method of claim 3, further comprising:
validating first login information associated with a second user ID, wherein the login information is received from a user over the network;
performing a database query to determine a list of group records in the group table associated with a student ID associated with the second user ID, wherein the list of group records in the group table associated with a student ID associated with the second user ID comprises the at least one group associated with at least one of the group records from the list of group records associated with the first user ID; and
causing the display of information regarding at least one group associated with at least one of the group records from the list of group records to the user associated with second user ID, where in the information comprises information from the first post record.

5. The method of claim 3, further comprising:
performing a database query to determine a list of user IDs associated with the group ID associated with the group with which the first post record is associated; and
transmitting a notification to an address associated with each user ID in the list of user IDs, the notification comprising information related to the post associated with the first post record.

6. The method of claim 5 wherein the notification is one of an email, an SMS message, a social media message, or an application notification.

7. The method of claim 5 wherein the address is one of an email address, a phone number, an IP address, or a mobile device identifier.

8. The method of claim 2, further comprising:
receiving information from the user related to creating a first signup related to the at least one group associated with at least one of the group records from the list of group records to the user;
creating a first signup record in a signup table, wherein the signup record comprises the first user ID, a first signup ID, and either the group ID of the at least one group or an activity ID of an activity associated with the at least one group.

9. The method of claim 8, further comprising:
validating first login information associated with a second user ID, wherein the login information is received from a user over the network;
performing a database query to determine a list of group records in the group table associated with a student ID associated with the second user ID, wherein the list of group records in the group table associated with a student ID associated with the second user ID comprises the at least one group associated with at least one of the group records from the list of group records associated with the first user ID; and
causing the display of information regarding at least one group associated with at least one of the group records from the list of group records to the user associated with second user ID, where in the information comprises information regarding the first signup.

10. The method of claim 9, further comprising:
receiving information from the second user indicating selection of a user interface element for sign up for the first signup;
creating a user sign up record in a user signup table, wherein the user signup record comprises the second user ID and the first signup ID.

11. The method of claim 2, further comprising:
receiving information from the first user related to an album related to the at least one group associated with at least one of the group records from the list of group records to the user;
creating a first album record in an album table, wherein the album record comprises the first user ID, a first album ID, and either the group ID of the at least one group or an activity ID of an activity associated with the at least one group.

12. The method of claim 11, further comprising:
creating a first photo record in a photo table comprising a first photo ID and the first album ID.

13. The method of claim 2, further comprising:
receiving information from the first user related to an event related to the at least one group associated with at least one of the group records from the list of group records to the user;
creating a first event record in an event table, wherein the event record comprises the first user ID, a first event ID, and either the group ID of the at least one group or an activity ID of an activity associated with the at least one group.

14. The method of claim 2, further comprising:
receiving information from the first user related to an attachment related to the at least one group associated with at least one of the group records from the list of group records to the user;
creating a first attachment record in an attachment table, wherein the attachment record comprises the first user ID, a first event ID, and either the group ID of the at least one group or an activity ID of an activity associated with the at least one group.
